(19) United States
(12) Patent Application Publication
(10) Pub. No.: US 2023/0222601 A1
(43) Pub. Date: Jul. 13, 2023

(54) PROCESSING TECHNIQUES AND SYSTEM ARCHITECTURES FOR AUTOMATED CORRESPONDENCE MANAGEMENT

(71) Applicant: STATE FARM MUTUAL AUTOMOBILE INSURANCE COMPANY, Bloomington, IL (US)

(72) Inventors: Matthew Aaron Mifflin, Bloomington, IL (US); Vincent M. Hummel, Roanoke, IL (US); Julie Ann Hozie, Bloomington, IL (US); Thomas A. Iott, Normal, IL (US); Timothy W. Robert, Bloomington, IL (US)

(21) Appl. No.: 18/174,921

(22) Filed: Feb. 27, 2023

Related U.S. Application Data
(63) Continuation of application No. 15/084,831, filed on Mar. 30, 2016, now abandoned.
(60) Provisional application No. 62/300,421, filed on Feb. 26, 2016.

(51) Int. Cl. G06F 40/186; H04L 51/046

(52) U.S. Cl. CPC G06F 40/186; H04L 51/046

(57) ABSTRACT

In a computer-implemented method for automated management of correspondence related to an insurance claim, an evaluation trigger (e.g., occurrence of a pre-scheduled time, a triggering event associated with the claim, and/or reception of an evaluation request from an application) may be detected and, in response, an evaluation may be performed. Performing the evaluation may include retrieving one or more data elements from a claims database, and/or generating evaluation output data by processing the retrieved data element(s) according to a first set of rules implemented by a rules engine. Based upon the evaluation output data, at least one action may be selected from among a set of potential actions. The set of potential actions may include automatically generating correspondence (or selected portions thereof) associated with the claim and scheduling a future evaluation. The selected action may then be performed using a second set of rules implemented by the rules engine.

### CROSS-REFERENCE TO RELATED APPLICATION

This application is a continuation of U.S. patent application Ser. No. 15/084,831, filed Mar. 30, 2016, which claims the benefit of U.S. Provisional Patent Application No. 62/300,421, filed on Feb. 26, 2016, the disclosure of which is hereby incorporated herein by reference in its entirety.

### FIELD OF THE DISCLOSURE

The present disclosure generally relates to correspondence management and, more specifically, to processing techniques and system architectures for automatically identifying, generating and scheduling correspondence.

### BACKGROUND

Particularly for larger companies and other organizations, managing outgoing correspondence (e.g., letters, emails, etc.) may be challenging. Correspondence management may be particularly difficult in industries such as insurance, where laws that vary from state to state require insurers to send out correspondence containing specific types of information (e.g., claim status, coverage limitations, etc.) within specified time limits (e.g., within 30 days of a claim being opened, etc.).

Some computing systems have been utilized to automate some simple types of correspondence. For example, some computing systems are capable of inserting dates, names, account numbers, etc., into particular fields within form letters. However, given the highly variable yet highly specific nature of legal requirements in different jurisdictions, correspondence is often too complex and/or costly to automate using routine and conventional processing techniques. To provide just a few examples, such techniques may be incapable of properly determining the content of various types of correspondence, the timing of the correspondence, and/or whether the correspondence should even be sent out at all. To provide a solution to these and other shortcomings, innovative processing techniques and system architectures capable of handling high levels of variability and complexity are needed.

### BRIEF SUMMARY

The present embodiments may, inter alia, use new processing techniques and system architectures to automatically manage correspondence, including identifying when particular types of correspondence are needed, automatically generating correspondence in the presence of complex and varying legal (and/or other) requirements, efficiently staging multiple pieces of correspondence for a single recipient, and/or other related functions.

In one aspect, a computer-implemented method for automatically generating correspondence may comprise: (1) exposing, by a services interface module of an automated correspondence management system (ACMS) implemented by one or more processors, an application programming interface (API) of the services interface module configured to receive event notifications from one or more applications via a network; (2) receiving, at the API of the ACMS, a plurality of event notifications of a corresponding plurality of events from the one or more applications, each of the event notifications including a respective event payload containing data specifying one or more properties of the respective event; (3) applying, by an event filter of the ACMS, a set of filter rules to the event payloads of the plurality of event notifications to generate a processing subset of the plurality of event notifications by removing a subset of the plurality of event notifications that match the filter rules; (4) processing, by an evaluation unit of the ACMS, the event payload of each of the event notifications of the processing subset to detect event triggers associated with events indicated by the event notifications; (5) when an evaluation trigger associated with one or more of the event notifications is detected, generating, by the evaluation unit of the ACMS, evaluation output data associated with the one or more event notifications by: (i) retrieving one or more additional data elements associated with the one or more event notifications from a database via the network; and (ii) applying an evaluation rule set to the corresponding event payloads and additional data elements associated with the one or more event notifications to generate the evaluation output data; (6) determining, by an implementation module of the ACMS, a type of correspondence associated with the one or more event notifications based upon the evaluation output data; (7) generating, by the implementation module of the ACMS, a correspondence document based upon the evaluation output data; (8) selecting, by the implementation module of the ACMS, a printer associated with a type of action for the correspondence document based upon the evaluation output data; and/or (9) routing, by the implementation module of the ACMS, the correspondence document to the printer to cause the printer to print the correspondence document. The method may include additional, less, or alternate actions, including those discussed elsewhere herein.

In another aspect, a computer system for automatically generating correspondence may comprise: one or more computing devices comprising one or more processors configured to implement an automated correspondence management system (ACMS) and communicatively connected to one or more additional computing devices implementing one or more applications, the ACMS comprising: (1) a services interface module configured to: (i) expose an application programming interface (API) of the services interface module configured to receive event notifications from the one or more applications via a network; and (ii) receive at the API a plurality of event notifications of a corresponding plurality of events from the one or more applications, each of the event notifications including a respective event payload containing data specifying one or more properties of the respective event; (2) an event filter configured to apply a set of filter rules to the event payloads of the plurality of event notifications to generate a processing subset of the plurality of event notifications by removing a subset of the plurality of event notifications that match the filter rules; (3) an evaluation unit configured to: (i) process the event payload of each of the event notifications of the processing subset to detect event triggers associated with events indicated by the event notifications; when an evaluation trigger associated with one or more of the event notifications is detected, generate evaluation output data associated with the one or more event notifications by: (a) retrieving one or more additional data elements associated with the one or more event notifications from a database via the network; and (b) applying an evaluation rule set to the corresponding event payloads and additional data elements associated with the one or more event notifications to generate the evaluation output data; and/or (4) an implementation module configured to: (i) determine a type of correspondence associated with the one or more event notifications based upon the evaluation output data; (ii) generate a correspondence document based upon the evaluation output data; (iii) select a printer associated with a type of action for the correspondence document based upon the evaluation output data; and (iv) route the correspondence document to the printer to cause the printer to print the correspondence document. The computer system may include additional, less, or alternate functionality, including that discussed elsewhere herein.

In another aspect, tangible, non-transitory computer readable medium storing instructions for automatically generating correspondence by implementing an automated correspondence management system (ACMS) may comprise instructions to: (1) expose, by a services interface module of the ACMS, an application programming interface (API) of the services interface module configured to receive event notifications from one or more applications via a network; (2) receive, at the API of the ACMS, a plurality of event notifications of a corresponding plurality of events from the one or more applications, each of the event notifications including a respective event payload containing data specifying one or more properties of the respective event; (3) apply, by an event filter of the ACMS, a set of filter rules to the event payloads of the plurality of event notifications to generate a processing subset of the plurality of event notifications by removing a subset of the plurality of event notifications that match the filter rules; (4) process, by an evaluation unit of the ACMS, the event payload of each of the event notifications of the processing subset to detect event triggers associated with events indicated by the event notifications; (5) when an evaluation trigger associated with one or more of the event notifications is detected, generate, by the evaluation unit of the ACMS, evaluation output data associated with the one or more event notifications by: (i) retrieving one or more additional data elements associated with the one or more event notifications from a database via the network; and (ii) applying an evaluation rule set to the corresponding event payloads and additional data elements associated with the one or more event notifications to generate the evaluation output data; (6) determine, by an implementation module of the ACMS, a type of correspondence associated with the one or more event notifications based upon the evaluation output data; (7) generate, by the implementation module of the ACMS, a correspondence document based upon the evaluation output data; (8) select, by the implementation module of the ACMS, a printer associated with a type of action for the correspondence document based upon the evaluation output data; and/or (9) route, by the implementation module of the ACMS, the correspondence document to the printer to cause the printer to print the correspondence document. The method may include additional, less, or alternate actions, including those discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts an exemplary environment in which techniques for automating correspondence management may be implemented, according to one embodiment.

FIG. 2 depicts an exemplary process flow for automated correspondence management, according to one embodiment.

FIG. 3 depicts an exemplary table of different types of correspondence that may be deemed necessary by an evaluation, according to one embodiment.

FIG. 4 depicts an exemplary correspondence template, according to one embodiment.

FIG. 5 depicts a flow diagram of an exemplary method for automated management of correspondence related to a claim, according to one embodiment.

FIG. 6 depicts a flow diagram of another exemplary method for automated management of correspondence related to a claim, according to one embodiment.

FIG. 7 depicts an exemplary process for staging correspondence requests associated with multiple evaluations, according to one embodiment and scenario.

FIG. 8 depicts an exemplary process for identifying a performer for automated correspondence, according to one embodiment.

FIG. 9 depicts an exemplary computer system in which the techniques described herein may be implemented, according to one embodiment.

### DETAILED DESCRIPTION

### I. Exemplary Automated Correspondence Management

The embodiments described herein relate to, inter alia, the automated identification, generation and scheduling of correspondence using a rules-based architecture. The systems and techniques described herein may be used, for example, in connection with claims for various different types of insurance, such as automobile, homeowners, renters, pet, burial, personal articles or personal property, and/or life insurance. For ease of explanation, the below description and accompanying figures will focus primarily on insurance-based embodiments and scenarios. However, those skilled in the art will appreciate that at least some of the technical advancements described below (and/or shown in the accompanying figures) are not necessarily restricted to the field of insurance, and may be used in other, non-insurance industries or fields.

In some embodiments, an automated correspondence management system evaluates data relating to a number of insurance claims, on a regular or irregular basis, to determine whether one or more actions should be taken. Evaluations may be initiated in response to various different types of triggers, such as the occurrence of a claim-related event (e.g., closing a claim, making a payment on a claim, receiving an estimate for a claim-related repair, etc.) that has been pre-defined as an evaluation trigger, the occurrence of a date at which an evaluation has previously been scheduled, and/or an evaluation request received from a software-based application (e.g., an application executed by a claims management system, a customer messaging application, etc.).

Once triggered, an evaluation may process various data elements (e.g., including data from a claims database) according to a set of rules implemented by a rules engine. The rule set may be based upon legal requirements (e.g., state laws governing insurance practices) and/or other factors (e.g., best practices of a company), and may specify both the types of correspondence that must be sent (e.g., a notice of a delay in claim processing, a notice of no intent to pursue subrogation, etc.) and the required timing of such correspondence (e.g., within 30 days of a particular claim-related event, etc.).

Depending upon the specific rules of the rule set and the specific values of the data elements being processed, an evaluation may initiate one or more actions. For example, the evaluation may identify a particular type of correspondence (e.g., a letter, email, text, etc.) that is needed (possibly with one or more attachments such as a payment, estimate, form, etc.), and cause the correspondence to be automatically generated, printed (if applicable), and sent out. As another example, the evaluation may identify the need for an additional evaluation at a future time (e.g., 30 days from the current date, 60 days from a particular claim-related event, etc.), and cause the future evaluation to be scheduled. In yet another example, the evaluation may recognize that a certain type of correspondence cannot be automatically generated, and cause instructions for a manual task to be generated and sent to an individual (e.g., a claim handler). In some embodiments and scenarios, the evaluation may instead result in no action being taken.

If an evaluation identifies the need for correspondence, the correspondence (and associated text therein) may be automatically generated. Any needed attachment(s) may also be automatically generated, or may be retrieved from the appropriate source (e.g., from a claim file or database). Generally, the correspondence generator may need to be capable of handling diverse scenarios and/or legal requirements. For example, the correspondence generator may need to select an appropriate template, recognize whether optional text should be included in a letter, and/or select one of multiple possible alternatives for various portions of the text. To this end, additional data elements (e.g., state of policy and/or accident, cause of loss information, whether an accident involved personal injury, and/or any other type of claim, policy and/or other data) may be processed according to another rule set implemented by the rules engine.

Once generated, correspondence may be routed to a printer, inserted in an envelope (e.g., using an automatic envelope insertion device), and sent to the appropriate individual (e.g., a policyholder). In some situations, however, bundling multiple pieces of correspondence and/or other documents (e.g., attachments) together may be desired to avoid mailing numerous different letters/documents to a single individual in a short time span, and/or to provide a cover letter for certain types of documents (e.g., an estimate, payment, form, etc.). Thus, a staging process may be used to identify which pieces of correspondence and/or documents should be bundled together, and to ensure that no one of those pieces of correspondence and/or documents is sent until all are completed and placed in one envelope (e.g., staging an auto repair estimate, a payment draft, and a cover letter).

By replacing conventional processing techniques and architectures with one or more of the processing techniques and architectures described herein, problems that have beset the field of automated correspondence management to date may be overcome. For example, letters or other correspondence (emails, text messages, etc.) may be automatically initiated in the appropriate circumstances, with the appropriate timing, and with the appropriate content, even in the presence of highly variable and complex legal and/or other requirements or standards.

In one aspect, an application may be able to: specify optional text (to automate most letters); include rules that may specify variable text; schedule a future evaluation (for instance, many legislative letters are time sensitive such as “5 years from the date of loss”, etc.); schedule a future evaluation for any date/time in the future; schedule a reoccurring evaluation (some states may require Status Delay Letter(s) and/or require letters to be sent every 30 days; trigger a letter as well as a future evaluation (the future evaluation may trigger a letter and a future evaluation, and so on as needed); specify a printer override for an automatic letter to direct the automatic letter(s) to print to (some letters may require special handling such as inserting a pamphlet or providing a handwritten signature); routing to various facilities; create a cover page with instructions that prints out with letters (such as instructions to retrieve from a printer and to include a pamphlet); create manual tasks (some letters may be associated with scenarios where there is a need to evaluate claim data, and either trigger a letter or a task to a claim handler); and/or use the rules engine to identify multiple letters and attachments (e.g., estimate, payment, form, etc.) that will be sent together.

### II. Exemplary Environment for Automated Correspondence Management

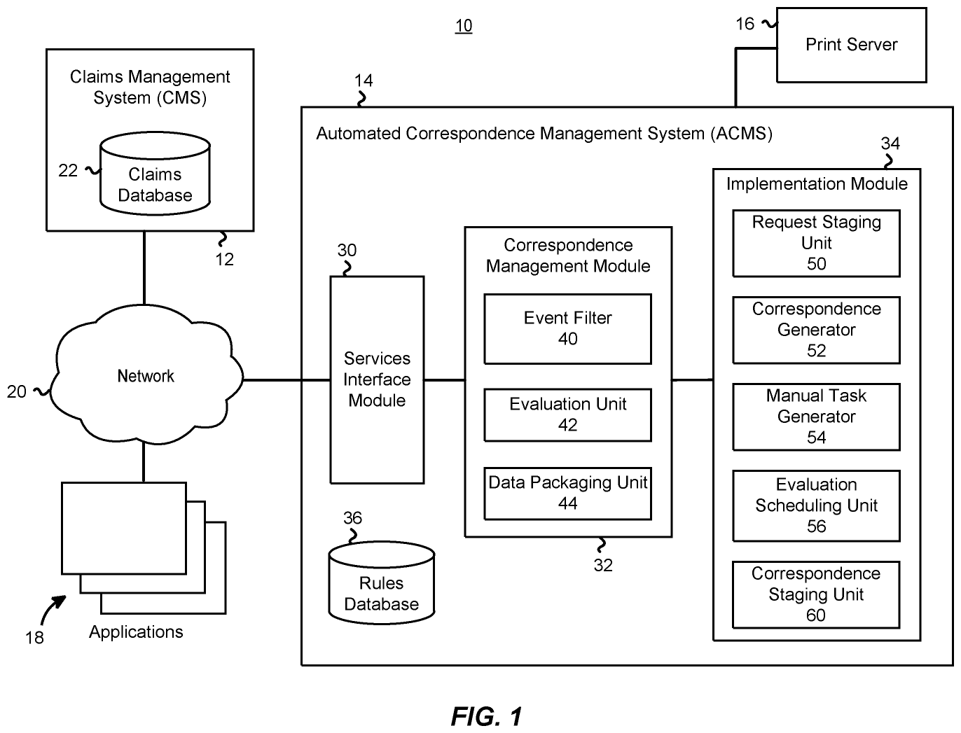

FIG. 1 depicts an exemplary environment 10 in which techniques for automated correspondence management may be implemented, according to one embodiment. The environment 10 may include a claims management system (CMS) 12, an automated correspondence management system (ACMS) 14, a print server 16, a number of applications 18, and a network 20. In other embodiments, however, the environment 10 may include more, fewer or alternate components as compared to those shown in FIG. 1, such as any of those discussed elsewhere herein, for example. In one embodiment where ACMS 14 does not handle any physical correspondence (e.g., letters), for instance, the environment 10 may omit print server 16.

CMS 12 generally manages claim information for one or more insurance sectors (e.g., auto and/or other vehicle insurance, homeowners or renters insurance, life insurance, personal articles insurance, etc.), and may include a claims database 22 containing information relating to the insurance claims of a number of individuals (e.g., customers/policyholders). CMS 12 may, for example, collect claim information based upon inputs from claims associates and/or other individuals and/or entities, create and/or update records in claims database 22 as needed, and/or generate various outputs (e.g., reports, notifications or alerts when certain claim-related events occur, etc.). While not shown in FIG. 1, CMS 12 may also include, or have access to, a policy database containing information associated with insurance policies for a number of customers.

ACMS 14 generally identifies scenarios in which particular types of correspondence are needed, and the appropriate timing of the correspondence. ACMS 14 may also automatically generate the correspondence in accordance with various requirements (e.g., state-specific laws or regulations) and/or standards (e.g., best practices specified by an insurance company). In some embodiments, ACMS 14 may further include various other types of functionality, including any or all of the functionality discussed further below.

Print server 16 generally manages a printing system that includes one or more printers. Print server 16 may be a dedicated server that only receives and executes printing jobs from ACMS 14, or may receive and execute printing jobs from various other sources as well. In some embodiments, ACMS 14 instead acts as the print server for a number of printers. While not shown in FIG. 1, CMS 12 may also include, or be communicatively coupled to, an envelope insertion device that is configured to automatically insert contents (e.g., letters and attachments) into envelopes.

Applications 18 may include any number of software applications (e.g., 1, 3, 10, 20, etc.), each having a different purpose and/or different functionality. For example, applications 18 may include a customer messaging application, a loss reporting tool, or any other type of application that may have a need to trigger an evaluation of whether correspondence should be generated, and/or that may provide documents that might be included with outgoing correspondence.

Network 20 may communicatively couple ACMS 14 with CMS 12, and also communicatively couple ACMS 14 with applications 18, to enable the exchange of data. While shown as a single entity in FIG. 1, network 20 may include multiple communication networks of one or more types (e.g., one or more wired and/or wireless local area networks (LANs), and/or one or more wired and/or wireless wide area networks (WANs) such as the Internet). Moreover, ACMS 14 may reuse at least some of the same portions of network 20 to communicate with both CMS 12 and one or more of applications 18, or may use entirely different portions of network 20 to communicate with CMS 12 and applications 18. Further, the same or different portions of network 20 may be used to communicatively couple ACMS 14 with different ones of applications 18. Those skilled in the art will appreciate various types of networks that are appropriate for network 20, depending upon, for example, whether CMS 12, ACMS 14 and/or applications 18 are localized or distributed across a large geographic area.

ACMS 14 may include a services interface module 30, a correspondence management module 32, an implementation module 34 and a rules database 36. Services interface module 30 may generally be configured to communicate with CMS 12 and applications 18 via network 20. For example, network 20 may include the Internet, and services interface module 30 may provide a web services interface that enables CMS 12 and applications 18 to access ACMS 14. Alternatively, or in addition, services interface module 30 may be associated with an application programming interface (API) that is exposed to CMS 12 and/or one or more of applications 18. Other suitable interface technologies may also, or instead, be used to communicate with CMS 12 and/or one or more of applications 18.

Services interface module 30 may receive various types of information from CMS 12 and applications 18. For example, CMS 12 may send notifications to services interface module 30 (e.g., via push and/or pull technologies) whenever a claim-related event, from a list of pre-defined events, occurs. For instance, CMS 12 may send to services interface module 30, via network 20, an indication whenever a claim represented in claims database 22 is opened, a claim is closed, a participant is added to the claim or updated, a claim cause of loss is created or updated, a vehicle is added to the claim or updated, and so on.

In various different embodiments, each event indication may be a simple identifier or code representing the type of event, or may include additional information. For example, each event indication may include an “event payload,” generated by CMS 12, that includes not only an identifier of the type of event, but also a relatively small amount of other information specifying one or more properties of the event (e.g., properties specific to that particular instance of the event, such as date, type, etc.). Moreover, in some embodiments, the types of information included in the event payload may vary based upon the type of event that occurred. In one embodiment and scenario, for example, an event payload may include an event type identifier indicating a “participant added” event, and also specify a number of different participant properties (e.g., an indication of whether the participant is a claimant, an indication of whether the identity of the participant is currently unknown, an indication of whether the participant owns or is otherwise associated with a vehicle involved in the claim, etc.).

In addition to event notifications, services interface module 30 may receive other types of information from CMS 12 and/or applications 18. For example, CMS 12 and/or one or more of applications 18 may send evaluation requests to services interface module 30 via network 20. Each evaluation request may request that ACMS 14 evaluate whether correspondence is needed, and/or the timing of such correspondence, as discussed further below. As another example, CMS 12 and/or one or more of applications 18 may send data representing the contents of certain documents to services interface module 30, via push and/or pull technologies. The documents may be ones that are to be sent to customers or other individuals (e.g., an estimate to be sent to a policyholder), and may be provided to ACMS 14 to allow ACMS 14 to manage the sending of the document (e.g., by controlling the recipient, the timing of sending the document, etc., and/or by bundling the document with one or more other pieces of correspondence, etc.).

Service interface module 30 may relay received information to correspondence management module 32, package the received information for processing by correspondence management module 32, and/or generate new messages for correspondence management module 32 based upon the received information. To perform various functions (described further below) based upon the information and/or messages received from services interface module 30, correspondence management module 32 may include an event filter 40, an evaluation unit 42 and a data packaging unit 44.

Because CMS 12 may handle many claims at any given time, and because a sizable number of different events may occur in connection with any one claim, CMS 12 may send a very large number of event indicators to services interface module 30 (e.g., tens or hundreds of thousands per day). To reduce the burden on the processing resources of ACMS 14, event filter 40 may serve as a gateway that removes from further consideration events that meet a set of one or more pre-defined filter criteria. In one simple example, event filter 40 may filter out particular types of events for which it is known that no correspondence will be needed. In some embodiments where each event indicator includes an event payload with multiple information fields, however, the filter criteria may be more complex. For example, event filter 40 may filter out all “participant added,” “participant updated” and/or “participant removed” events in which the participant is an unknown participant, because it is not possible to send correspondence to someone whose identity is not known.

In some embodiments, event filter 40 does not retrieve or process any claim-related data outside of the event payloads, thereby significantly reducing the required amount of processing resources. The filter criteria may be implemented by rules stored in rules database 36 (discussed further below in connection with evaluation unit 42), or may programmed independently of rules database 36, for example.

Events that have not been removed by event filter 40 may be considered by evaluation unit 42 on a one-by-one basis using serial and/or parallel processing. More specifically, evaluation unit 42 may process the remaining event indicators and/or event payloads to determine whether any particular action(s) should be taken by implementation module 34, such as generating correspondence, generating instructions for a manual task, and/or scheduling a future evaluation, for example. To make this determination, evaluation unit 42 may implement a rules engine that applies rules from rules database 36 to a number of different facts. The facts may be based upon data elements gathered from the event payloads, and/or one or more data elements retrieved from CMS 12 (e.g., claims database 22) and/or other sources.

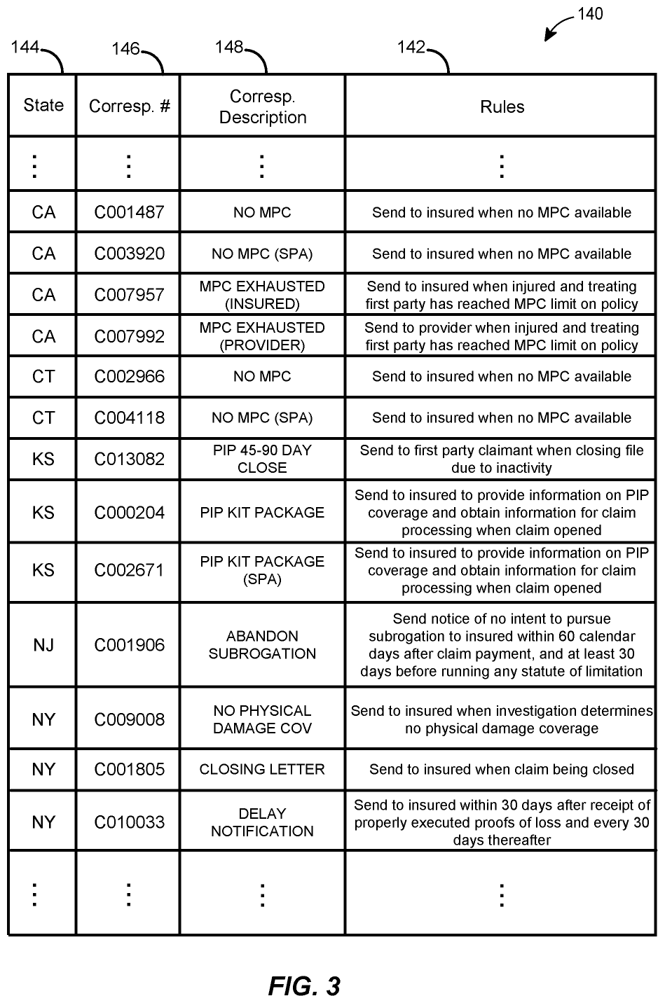

The rules in rules database 36 may be designed to reflect various requirements, standards and/or best practices. For example, the rules may be designed to enforce compliance with laws or regulations on a state-by-state basis, in which case one of the data elements processed by evaluation unit 42 may be an indicator of the state in which the policyholder lives (and/or the state in which an accident occurred, etc.). The rules applied by evaluation unit 42 may specify whether any correspondence is needed, whether a particular type of correspondence is needed, the timing of sending the correspondence, and/or whether the need for correspondence should be reconsidered at a particular future time, for example. More specific examples of state law-based rules that may be applied by evaluation unit 42 are provided below in connection with FIG. 3.

As noted above, in some embodiments, CMS 12 and/or one or more of applications 18 may request evaluations. When services interface module 30 receives such a request, evaluation unit 42 may initiate an evaluation without necessarily having identified any particular evaluation-triggering event. Similarly, evaluation unit 42 may initiate an evaluation without having identified any particular evaluation-triggering event in embodiments and scenarios where an evaluation has been scheduled for a particular date (e.g., as discussed further below in connection with implementation module 34). In either scenario (i.e., a requested or scheduled evaluation), evaluation unit 42 may retrieve data elements from CMS 12 and/or other sources to determine which action implementation module 34 should take.

If evaluation unit 42 determines that one or more actions should be taken, evaluation unit 42 may request or instruct that implementation module 34 implement the action(s). In some embodiments, to reduce the processing resources required by implementation module 34, data packaging unit 44 may assemble and/or format information that will or may be needed by implementation module 34 to execute the prescribed action(s). For example, data packaging unit 44 may retrieve from claims database 22 (and/or a policy database, etc.) any additional data elements that may need to be considered by implementation module 34, and construct an action request payload that includes the retrieved data elements. Data packaging unit 44 may also, or instead, add to the payload any of the data elements that were already retrieved/processed by evaluation unit 42. The payload may then be forwarded to implementation module 34, within the action request, for further processing.

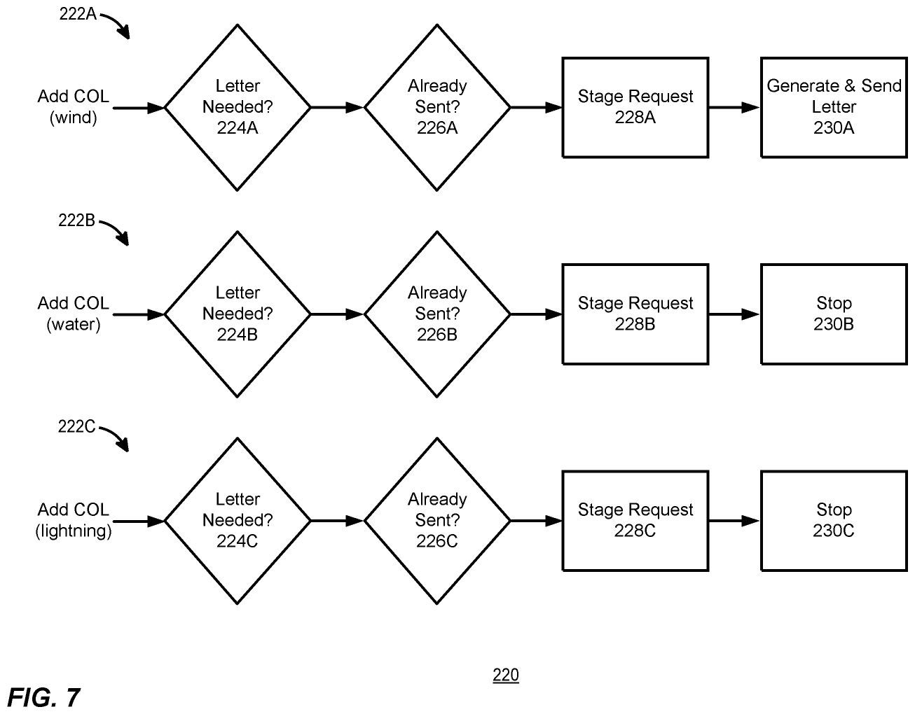

To implement the action(s) requested by correspondence management module 32, implementation module 34 may include a request staging unit 50, a correspondence generator 52, a manual task generator 54, an evaluation scheduling unit 56 and a correspondence staging unit 60. Request staging unit 50 generally serves to avoid scenarios in which multiple requests for the same action (e.g., parallel requests that a specific a letter be generated and sent out to a specific recipient) result in that action being repeated multiple times. The operation of request staging unit 50 is described in more detail below in connection with FIG. 7, according to one embodiment.

Implementation module 34 may identify the type of action or actions requested by correspondence management module 32, and may select correspondence generator 52, manual task generator 54 and/or evaluation scheduling unit 56 to implement the identified action(s). If a particular type of correspondence has been requested (e.g., a letter, email, text message, on-line account message, phone call, etc.), correspondence generator 52 may automatically generate the content for that correspondence. In some embodiments, correspondence generator 52 may also automatically configure the presentation and/or format of the correspondence content.

To generate the content of the correspondence, correspondence generator 52 may apply additional rules from rules database 36 to a set of facts. The facts may be based upon some of the same data elements previously considered by evaluation unit 42, and/or other data elements from claims database 22 and/or one or more other sources. The data elements considered/processed by correspondence generator 52 may be contained entirely within a request payload from data packaging unit 44, and/or may include one or more additional data elements retrieved by correspondence generator 52 or another component of implementation module 34, for example.

As with the rules applied by evaluation unit 42, the rules applied by correspondence generator 52 may be designed to reflect various requirements (e.g., state laws or regulations), standards and/or best practices. The rules applied by correspondence generator 52 may be used to select an appropriate template, to determine whether optional text should be included, and/or to choose from among a number of alternative blocks of text, for example. Correspondence generator 52 may also perform simpler tasks, such as populating blank fields of a template with standard information (e.g., customer name, current date, etc.) based upon codes associated with those fields, without necessarily applying any rules from rules database 36.

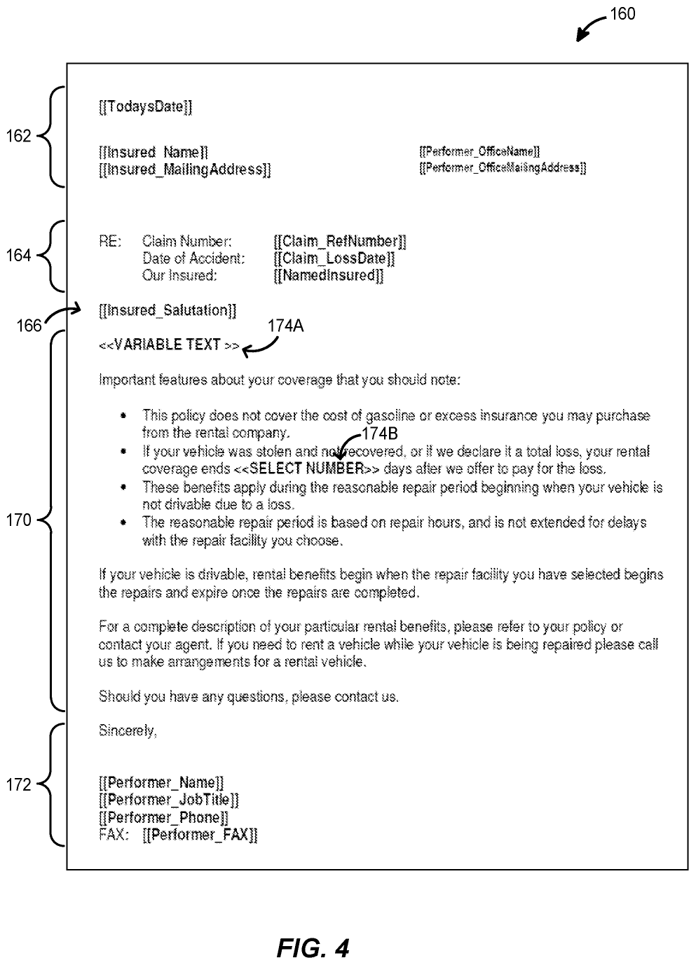

In various different embodiments and/or scenarios, the recipient(s) of a particular piece of correspondence and/or the correspondence channel/type (e.g., letter, email, etc.) may have been previously determined by evaluation unit 42, or may be determined by correspondence generator 52. More specific examples of rules that may be applied by correspondence generator 52 are provided below in connection with FIG. 4. Each piece of correspondence generated by correspondence generator 52 may be forwarded to correspondence staging unit 60, discussed further below.

In scenarios where evaluation unit 42 has determined that one or more attachments are needed with a piece of correspondence, correspondence generator 52 may automatically generate the attachment(s), and/or retrieve one or more of the attachments from the appropriate source(s). If evaluation unit 42 determined that an estimate and a payment draft should be provided as attachments to a cover letter, for example, correspondence generator 52 may retrieve the estimate document (e.g., from claims database 22 or another source), generate the payment draft (or cause another computing device or system to generate the payment draft), generate the cover letter, and cause all three items to be forwarded to correspondence staging unit 60.

In scenarios where evaluation unit 42 determines that a particular type of correspondence is or may be needed, but recognizes that correspondence generator 52 is not or may not be capable of generating the correspondence, correspondence management module 32 may request that implementation module 34 generate instructions for one or more manual tasks. In response to the request, manual task generator 54 may process one or more data elements (e.g., data elements that data packaging unit included in a request payload) according to additional rules from rules database 36, and generate a set of instructions for the manual task(s). For example, manual task generator 54 may generate instructions stating that a particular type of letter should be prepared, and further stating that the drafter should work with the legal department to prepare the letter. As another example, correspondence management module 32 may request that implementation module 34 generate instructions to manually locate and download a certain type of attachment that is not readily available to correspondence generator 52.

Manual task generator may then cause print server 16 to print out the instructions (e.g., with an automatically generated cover letter indicating the intended recipient(s)), and/or may cause a message containing the instructions to be routed (e.g., emailed) to the appropriate recipients. In some embodiments, some or all of the functionality of manual task generator 54 may instead be implemented by evaluation unit 42. Moreover, in some embodiments, manual task generator 54 may instead, or additionally, be called to generate instructions by correspondence generator 52 (e.g., in scenarios where correspondence generator 52 attempts to generate a document, but is unsuccessful).

In scenarios where evaluation unit 42 determines that another evaluation should be performed at one or more future dates, correspondence management module 32 may request that implementation module 34 schedule the evaluation for those dates. In response to the request, evaluation scheduling unit 56 may initiate a process (e.g., cause an electronic record stored in a memory of ACMS 14 to be updated) that will trigger an evaluation by evaluation unit 42 upon occurrence of the scheduled date(s). In some embodiments, the functionality of evaluation scheduling unit 56 may instead be incorporated in evaluation unit 42.

In some embodiments and scenarios, a single evaluation trigger (e.g., a single claim-related event, a scheduled date, or a single evaluation request from CMS 12 or one of applications 18) may result in correspondence management module 32 sending implementation module 34 multiple requests each corresponding to a different action, or sending a single request message specifying multiple actions. For example, evaluation module 42 may determine, after processing a particular event payload, that a notice letter should be generated, and also that another evaluation should be scheduled 30 days out. As another example, evaluation module 42 may determine, after processing a particular event payload, that two or more different letters should be generated, or that a single letter should be generated and sent with one or more attachments (e.g., an estimate, a payment, a form, etc.).

Correspondence staging unit 60 may generally manage the timing with which correspondence generated by correspondence generator 52 (including any attachments(s) retrieved and/or generated by correspondence generator 52) is sent out, subject to constraints imposed by evaluation unit 42 (and/or constraints determined by correspondence generator 60 when applying additional rules in rules database 36, etc.). For example, upon processing a claim payment event and various other data elements (e.g., state, subrogation status, etc.), evaluation unit 42 may determine that a notification of no intent to pursue subrogation must be sent within 30 calendar days after the claim payment date. The action request sent to implementation module 34 by data packaging unit 44 may then include both an indication of the type of letter and an indication of the letter deadline. Implementation module 34 may then forward the letter type to correspondence generator 52, and forward the deadline to correspondence staging unit 60.

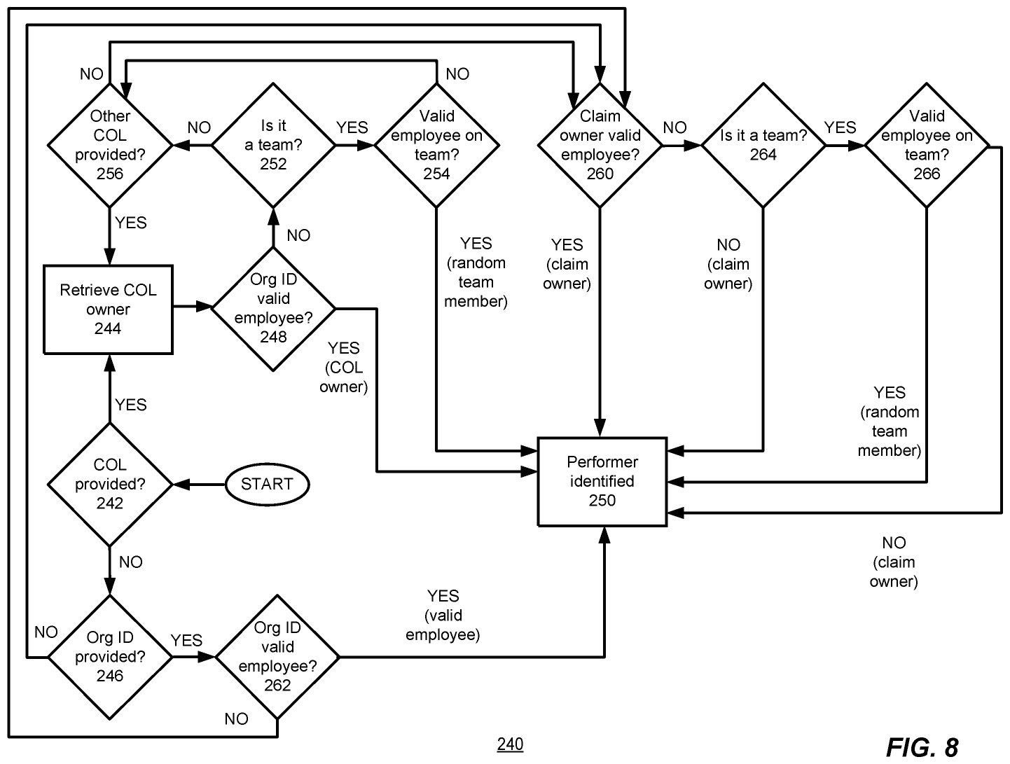

In some embodiments, correspondence staging unit 60 may be coupled to print server 16, and instruct print server 16 to print out letter correspondence when (or shortly before) correspondence staging unit 60 schedules the sending of such correspondence. In some scenarios, correspondence staging unit 60 may cause print server 16 to route letter correspondence to specific printers associated with “performers” who should physically sign the correspondence. Performers are discussed further below with respect to FIG. 8.

Correspondence staging unit 60, or another unit of ACMS 14 (e.g., manual task generator 54) may also instruct print server 16 to print out instructions for various pieces of correspondence, such as instructions to manually add an informational pamphlet to an envelope containing the correspondence.

Correspondence staging unit 60 may also, or instead, be coupled to one or more electronic communication systems in order to control the timing with which other types of correspondence (e.g., emails, SMS text messages, on-line account messages, voice or audio messages, etc.) are to be sent out (or transmitted via wireless communication or data transmission over one or more radio frequency links, and/or wireless communication channel(s)). In some embodiments, correspondence staging unit 60 may manage not only the timing of correspondence, but also the channel or medium by which each piece of correspondence is mailed out (e.g., letter, email, wireless communication, etc.). To identify the proper channel(s), and/or to identify the appropriate performer to sign a letter (or to be otherwise identified on the letter), correspondence staging unit 60 may utilize rules of rules database 36.

Correspondence staging unit 60 may generally schedule certain types of correspondence to be sent as soon as is practicable or, alternatively, may wait until the deadline is nearer. Moreover, in some embodiments and scenarios, correspondence staging unit 60 (or another unit or module of ACMS 14) may recognize that a number of different letters are being, or soon will be, generated for a particular recipient. In such a scenario, correspondence staging unit 60 may stage the various letters such that all of the letters are sent to the recipient at the same time. Such an approach may allow the recipient to avoid the irritation of receiving a number of different letters in a short amount of time, and allow the sender to reduce postage and/or other costs. In other scenarios, this approach may allow attachments (e.g., estimates, payments, forms and/or other attachments identified by evaluation unit 42 and/or retrieved or generated by correspondence generator 52) to be sent along with the corresponding cover letters and/or other pieces of correspondence.

To properly stage multiple letters and/or other documents (e.g., attachments), each document to be included in a particular bundle/package of documents may be assigned a respective status (e.g., successful, pending or failed). Each time that correspondence generator 52 generates or retrieves one of the documents to be bundled, correspondence staging unit 60 may check the status of the other documents in the bundle. Once all documents in the bundle have successfully been generated (e.g., including a cover letter) and/or retrieved, correspondence staging unit 60 may instruct print server 16 to print each document in the bundle. If correspondence staging unit 60 determines that one or more of the documents will fail to comply with a time limit identified by evaluation unit 42, however, correspondence staging unit 60 may cause the urgent document(s) to be printed and sent out without waiting for the remaining document(s) to be successfully generated.

In some embodiments and scenarios, and as seen from some of the examples provided above, correspondence staging unit 60 also manages the timing of sending out documents from sources external to ACMS 14. For example, services interface module 30 may receive a repair estimate document from one of applications 18 (e.g., after evaluation unit 42 has identified the need to send the estimate to the insured, and after correspondence generator 52 has requested the estimate from that application), and forward that estimate to correspondence staging unit 60 with the status of a successfully completed document. After a subsequent event (e.g., a payment being made to the vendor providing the estimate), evaluation unit 42 may determine that a notice letter to the policyholder/claimant is required. After correspondence generator 52 successfully generates the notice letter, correspondence staging unit 60 may instruct print server 16 to print the estimate document and the notice letter, along with a cover letter explaining the purpose of both to the intended recipient.

The rules contained in rules database 36 and applied by evaluation unit 42, correspondence generator 52, manual task generator 54 and/or evaluation scheduling unit 56 (and possibly other units, such as event filter 40 and/or correspondence staging unit 60) may be updated from time to time (e.g., to reflect changes in state laws or regulations), and/or supplemented with new rule sets as needed. To provide just a couple of examples, a terminal or client device (not shown in FIG. 1) may be used to upload a new rule set or rule updates to ACMS 14 for storage in rules database 36, and/or a portable memory device may be used to transfer a new rule set or rule updates to ACMS 14 for storage in rules database 36.

While shown in FIG. 1 as a single entity, it is understood that rules database 36 may, in some embodiments, be distributed across multiple databases and/or multiple physical/hardware memories, and/or may be wholly or partially external to (e.g., remote from) ACMS 14. Moreover, while references are made herein to a “rules engine” executing the rules of rules database 36, it is understood that the rules engine may, in some embodiments, include multiple component rules engines and/or be implemented by multiple different processors. For example, the rules engine may be implemented by multiple processors and/or computing devices each associated with different ones of event filter 40, evaluation unit 42, correspondence generator 52, manual task generator 54, evaluation scheduling unit 56 and/or correspondence staging unit 60.

In some embodiments, each of services interface module 30, correspondence management module 32 and/or implementation module 34 may be a software component stored in a persistent memory of, and implemented by one or more processors of, a respective computing device (e.g., a server). In other embodiments, some or all of services interface module 30, correspondence management module 32 and implementation module 34 may be software components stored in a persistent memory of, and implemented by one or more processors of, a single server or other computing device. Other arrangements are also possible, such as each of services interface module 30, correspondence management module 32 and/or implementation module 34 being a software component that is stored and executed in multiple computing devices in a distributed manner.

### III. Exemplary Process Flow for Automated Correspondence Management

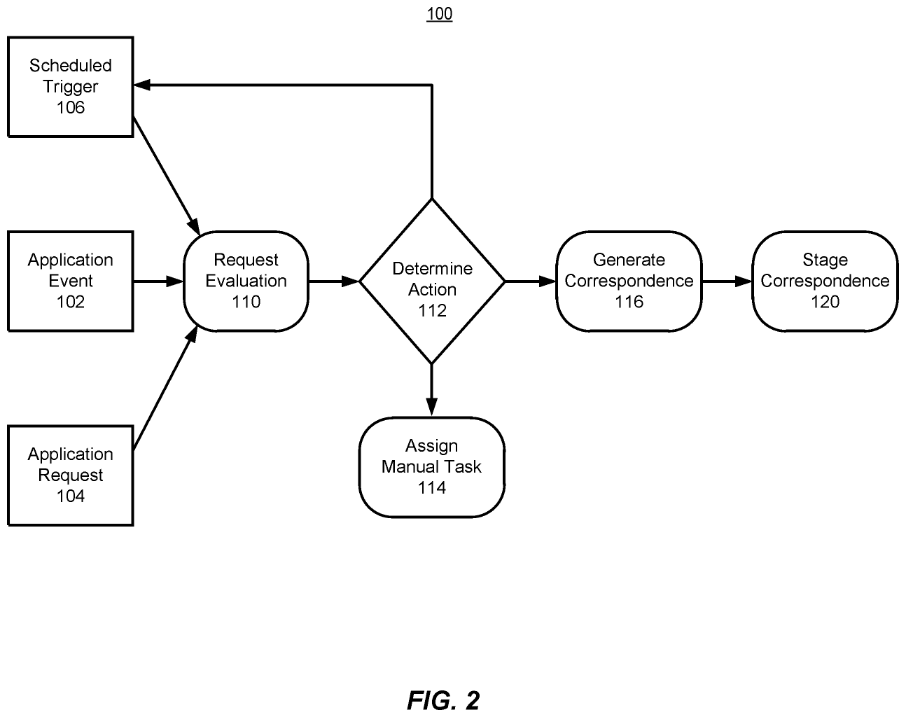

FIG. 2 depicts an exemplary process flow 100 for automated correspondence management, according to one embodiment. The process flow 100 may be implemented by ACMS 14 of FIG. 1, for example.

In the process flow 100, an application event 102, an application request 104 or a scheduled trigger 106 may serve as an input that triggers an evaluation request process 110. Application event 102 may be one event in a pre-determined list of events, with each event in the list being associated with a unique event code (e.g., a code recognizable by evaluation unit 42 of FIG. 1 to identify the event type). In some implementations, the list of events may be composed of a number of events to which a particular application (e.g., CMS 12 or one of applications 18 of FIG. 1) has previously subscribed. As a non-limiting example, the list of events may include some or all of the following events:
Participant added
Participant updated
Participant cause of loss (COL) created
Participant COL updated
Claim re-opened
Claim reviewed
Claim COL created
Electronic funds transfer (EFT) letter sent
Vehicle added
Vehicle updated
Claim folder updated
Claim payment made
Subrogation opened for claim
Subrogation closed for claim
Subrogation closed without deductible refund
Non-OEM part indicated in auto repair estimate
“Dummy” event (e.g., an event manually generated by a user, or generated by an application, to force an evaluation).

Application request 104 may be a direct request/call made by an application (e.g., CMS 12 or one of applications 18 of FIG. 1) via a web-based or other service (e.g., via services interface module 30 of FIG. 1). For example, an application may, after receiving a document to be sent to a customer (e.g., to be sent to a policyholder with a pending claim), request an evaluation to determine whether any other correspondence for the customer should be included with that document.

Scheduled trigger 106 may be the occurrence of a date that was scheduled in response to a previous evaluation (as discussed below). Alternatively, in some embodiments, scheduled trigger 106 may be a date that was either manually set by an operator or automatically set by an application (e.g., CMS 12 or one of applications 18 of FIG. 1).

The evaluation request process 110 may initiate an action determination process 112. The action determination process 112 may implement a rules engine that applies a set of pre-defined rules to a number of data elements (e.g., an event type, and/or a number of other data elements retrieved from one or more databases). The action determination process 112 may operate in a manner similar to evaluation unit 42, as described above in connection with FIG. 1, for example. In some embodiments and scenarios, a large number of data elements (e.g., tens, hundreds, etc.) may be processed during action determination process 112. To provide just a small set of non-limiting examples, the data elements processed by action determination process 112 or evaluation unit 42 may include some or all of the following data elements:
Claim number
Claim state (e.g., California, New York, etc.)
Claim status (e.g., pending, closed, etc.)
Line of business (e.g., auto, home, etc.)
Loss location
Loss reported date
Participant identifier
Participant type
Participant address
Participant birth date
Participant death date
“At fault” indicator (e.g., indication of which party was at fault)
Insurance policy number
Insurance policy state
Vehicle make
Vehicle model
Vehicle year
Personal injury indicator (e.g., indication of whether accident involved injury)
Injury description code
Buildup or fraud investigation indicator (e.g., indication of whether investigation initiated)

In the example process flow 100, the action determination process 112 may result in one of three actions, or no action at all. If it cannot be determined with certainty by the action determination process 112 that any correspondence should be sent out, but circumstances make it possible or likely that correspondence will be needed at a specific future date, then a scheduled trigger 106 may be set. If it is determined during the action determination process 112 that correspondence should be sent out, but that the correspondence is beyond the capabilities of the system implementing the process flow 100, then a manual task assignment process 114 may be initiated. Manual task assignment process 114 may generate text instructions specifying the needed task, and cause those instructions to be sent to (or printed for) a responsible individual. The manual task assignment process 114 may operate in a manner similar to manual task generator 54, as described above in connection with FIG. 1, for example. In some embodiments, action determination process 112 also, or instead, calls manual task assignment process 114 in other scenarios, such as when action determination process 112 detects an error condition or inconsistency, and a responsible individual is needed to review the matter.

If it is instead determined during the action determination process 112 that correspondence should be sent out, and that the correspondence can be handled by the system implementing process flow 100, then a correspondence generation process 116 may be initiated. The correspondence generation process 116 may operate in a manner similar to correspondence generator 52, as described above in connection with FIG. 1, for example.

After correspondence is generated, a correspondence staging process 120 may be called to manage the timing of sending the correspondence, including the bundling of multiple pieces of correspondence (possibly including an estimate, payment, form, and/or other attachment(s)) for a single recipient, where appropriate. Correspondence staging process 120 may also select the communication channel/medium on which the correspondence is to be sent (e.g., via letter, email, text message, voice or audio message, etc.), and/or include other functionality. The correspondence staging process 120 may operate in a manner similar to correspondence staging unit 60, as described above in connection with FIG. 1, for example.

To illustrate the operation of the process flow 100, according to one insurance-related embodiment, the application of an example rule set (e.g., rules within rules database 36 of FIG. 1) will now be described. The example rule set relates to correspondence for notifying customers of the status of claim processing delays. Under the rule set, a first evaluation (i.e., a first instance of the action determination process 112) is triggered by application event 102, with the application event 102 being the creation of a cause of loss (COL) for a claim. The rule set may dictate that no action be taken unless the action determination process 112 determines that all of the following criteria are met (according to the appropriate data element values):
(1) the cause of loss (COL) type code is one of a pre-defined subset of codes (e.g., a first party property cause of loss code, a rental cause of loss code, etc.);
(2) the cause of loss status code is either “open,” “re-opened” or “coverage question”;
(3) the claim state code is “NJ” (New Jersey); and
(4) there is no pending scheduled trigger for the same letter type.

If all of the above conditions are met, under the example rule set, the action determination process 112 may determine the number of days that have passed since the loss reporting date for the claim. If less than 27 days have passed, the action determination process 112 may set scheduled trigger 106 to be 27 days after the loss reporting date, and take no other action. If at least 27 days have passed, however, the action determination process 112 may cause the correspondence generation process 116 to generate the required notification letter, and also set scheduled trigger 106 to be 27 days after the date of application event 102 (i.e., 27 days after the cause of loss creation date). Thus, future instances of the action determination process 112 may be triggered by scheduled trigger 106, with each instance potentially resulting in a delay status notification letter and an additional scheduled trigger 106 (e.g., another 27 days in the future).

### IV. Exemplary Correspondence Table

FIG. 3 depicts an exemplary table 140 of different types of correspondence that may be deemed necessary during an evaluation, according to one embodiment. The table 140 may reflect rules stored in rules database 36 and applied by evaluation unit 42 of FIG. 1, and/or applied during the action determination process 112 of FIG. 2, for example.

As seen in FIG. 3, the table 140 may specify a number of rules 142, states 144 in which the rules 142 apply, correspondence numbers 146 and correspondence descriptions 148. Each of correspondence numbers 146 and correspondence descriptions 148 reflects one particular type of correspondence (e.g., a notice of a specific type of circumstance, etc.). The rules 142 shown in FIG. 3 are purely for illustrative purposes, and may or may not reflect any actual past, existing or future laws in the states shown. Moreover, the rules 142 may not reflect the full complexity of each rule (e.g., the combinations of code values, and/or other data element values, required for the corresponding piece of correspondence to be generated). For example, although not explicitly shown in FIG. 3, each of the rules 142 may include a rule specifying that the listed correspondence be sent only if the state matches the corresponding state shown in FIG. 3 under states 144.

As seen in FIG. 3, one of the example rules 142 specifies that, in California, Correspondence No. C001487 (“No MPC,” i.e., a notice that no medical payments coverage is available) is to be sent to the insured when medical payments coverage is not available for the insured (e.g., as indicated by claims and/or policy data). While not shown in FIG. 3, the rule may also specify the time limits within which the “No MPC” letter must be sent (e.g., to avoid a fine or other penalty, etc.), if any such time limits exist under California law (or under a set of best practices reflected by the rule, etc.). As another example, one of the rules 142 specifies that, in New Jersey, Correspondence No. C001906 (“Abandon Subrogation,” i.e., a notice of no intent to pursue subrogation) is to be sent to the insured within 60 calendar days after a claim payment is made, and at least 30 days before running any applicable statute of limitations.

Each of rules 142 may be associated with one or more potential triggers (e.g., similar to application event 102, application request 104 and/or scheduled trigger 106 of FIG. 2). For example, the rule to determine whether Correspondence No. C001487 (“No MPC” letter) is to be sent may be triggered by a “claim opened” or “claim re-opened” event (and/or a scheduled trigger that was set after such an event, etc.), and/or Correspondence No. C001906 (“Abandon Subrogation”) may be triggered by a “claim payment” event.

When one of the rules 142 indicates that a particular type of correspondence (e.g., a specific one of correspondence numbers 146) is needed, that correspondence may be automatically generated (e.g., by causing correspondence generator 52 of FIG. 1, and/or the correspondence generation process 116 of FIG. 2, to generate the letter or other correspondence). Automatic generation of a particular type of correspondence may include applying additional rules (e.g., other rules in rules database 36 of FIG. 1) to select the appropriate correspondence template, and/or to select the appropriate language for correspondence containing optional and/or variable (e.g., fact-dependent) text, e.g., as discussed in further detail below in connection with FIG. 4.

### V. Exemplary Correspondence Template with Variable Text

FIG. 4 depicts an exemplary correspondence template 160, according to one embodiment. In some embodiments, the correspondence template 160 is automatically selected (e.g., by correspondence generator 52 of FIG. 1) each time that an evaluation determines that a particular type of correspondence (e.g., a specific one of correspondence numbers 146 of FIG. 3) is needed. In other embodiments, the correspondence template 160 may be one of multiple possible templates that may be used for a particular type of correspondence. In these latter embodiments, various rules (e.g., from rules database 36 of FIG. 1) may be applied to select the appropriate template based upon the relevant facts (e.g., claim-related and/or policy-related data elements). While the correspondence template 160 of FIG. 4 is in the form of a letter (e.g., a physical letter, or a pdf letter attachment, etc.), in other embodiments and/or scenarios the correspondence template 160 may be in the form of an email, text message, audio or voice message, virtual communication, posting to a secure virtual account that requires login credentials, or other form of communication.

As seen in FIG. 4, the correspondence template 160 may include a header 162, a caption 164, an introduction 166, a body 170 and/or a signature block 172. Each of the double-bracketed items in the correspondence template 160 ([[ . . . ]]) is a field that may be automatically populated with the indicated value. For example, the header 162 may be automatically populated with the date on which the correspondence is sent, the name and mailing address of the recipient/insured, and/or the name and mailing address of office of the performer for the correspondence (e.g., the individual responsible for handling any follow-up communications involving the correspondence), the caption 164 may be automatically populated with the claim number, the reported date of loss, and/or the name of the insured, and the footer 172 may be automatically populated with the name, job title, phone number and fax number of the appropriate performer. Each of the double-bracketed fields may be associated with a code indicating the type of data element to be used to populate the field, and one or more databases may be accessed to retrieve the corresponding data element value (e.g., a claims database such as claims database 22 of FIG. 1, a policy database, an internal employee database, etc.).

Each of the double arrow-bracketed fields in the correspondence template 160 (<< . . . >>) is a field that may require the application of one or more rules (e.g., in rules database 36) to populate. In the example embodiment of FIG. 4, the body 170 includes a first variable field 174A and a second variable field 174B. The rules may be applied to determine which set of text (e.g., word(s), phrase(s), sentence(s), paragraph(s), etc.) of multiple possible sets of text should be inserted in the first variable field 174A, and to determine which number should be inserted in the second variable field 174B.

As one example, the sets of text from which the text for the first variable field 174A is chosen may include the following:

Option #1
Your policy provides the following rental coverage:
We will repay your actual car rental expenses up to $16.00 per day while your vehicle is not drivable.
The most we will pay for rental expenses incurred in any one occurrence is $400.0.

Option #2
Your policy provides the following rental coverage:
We will repay your actual car rental expenses up to $25.00 per day while your vehicle is not drivable.
The most we will pay for rental expenses incurred in any one occurrence is

Option #3
Your policy provides the following rental coverage:
We will repay your actual car rental expenses up to 80% of your cost while your vehicle is not drivable.
The most we will pay for rental expenses incurred in any one occurrence is $500.0.

The rules may base the selection of one of Options #1 through #3 upon various data elements, such as a deductible level, a tier of insurance coverage, an indicator of the amount of damage to a vehicle of the insured, and so on. The rules may also select a number of days to insert in the second variable field 174B based upon similar data elements, and/or based upon other data elements (e.g., state in which the loss occurred, etc.).

As those skilled in the relevant art will appreciate, the correspondence template 160 represents just one of virtually limitless possibilities with respect to the type of correspondence, the content and format/presentation of the correspondence, and the number and types of fields to be populated within the correspondence.

### VI. Exemplary Methods for Automated Management of Correspondence Related to a Claim

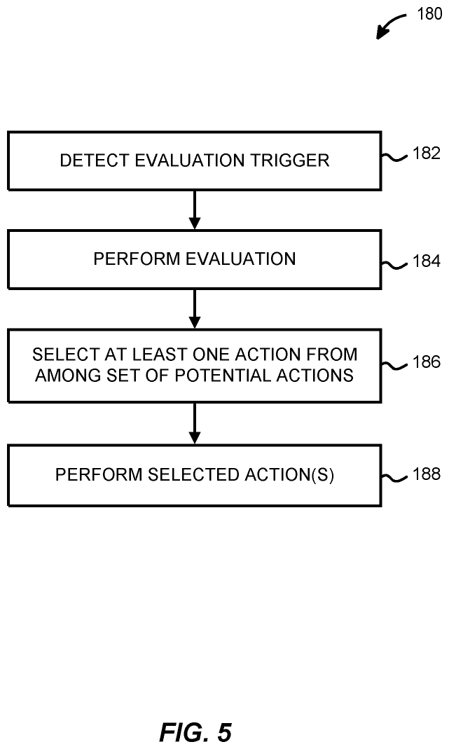

FIG. 5 depicts a flow diagram of an example method 180 for automated management of correspondence related to a claim, according to one embodiment. The method 180 may be implemented by one or more processors of one or more servers and/or other computing device(s), such as one or more processors of ACMS 14 of FIG. 1, for example.

In the example method 180, an evaluation trigger may be detected (block 182). The evaluation trigger may include an occurrence of a pre-scheduled time, a triggering event associated with the claim (e.g., one or more of a set of pre-defined events, including any or all of the example events discussed above in connection with FIG. 2, for example, and/or other events), and/or an evaluation request from an application (e.g., CMS 12 or one of applications 18 of FIG. 1). In some embodiments, other types of evaluation triggers are also possible (e.g., a manual trigger generated by a claim handler, etc.).

The evaluation trigger may be detected in various different ways, depending upon the embodiment and/or the type of trigger. For example, the occurrence of a pre-scheduled time may be detected by receiving an alert or message from a scheduling application. As another example, a triggering event may be detected by receiving push or pull event notifications from a claims management system (e.g., CMS 12 of FIG. 1). As yet another example, an application request may be detected by receiving a request message via a web service, or an API, etc.

In some embodiments, block 182 includes receiving data indicative of a plurality of events, associated with a plurality of different claims, from a claims management system (e.g., CMS 12 of FIG. 1), and processing at least a portion of that received data to detect the triggering event. The received data may include, for each of the events, a respective event payload specifying one or more properties of the event, and the processing of the data to detect the triggering event may include processing each of the respective event payloads to remove from consideration any events that meet one or more filter criteria (e.g., participant type “unknown” for a “participant added” event, etc.).

In response to detecting the evaluation trigger, an evaluation may be performed (block 184). Block 184 may include retrieving one or more data elements associated with the claim from a claims database (e.g., claims database 22 of FIG. 1, either directly or via CMS 12), and generating evaluation output data by processing the retrieved data element(s) according to a first set of rules implemented by a rules engine. The data element(s) may include any or all of the example data elements discussed above in connection with FIG. 2, for example, and/or other data elements. The first set of rules may be configured to ensure compliance with one or more state laws or regulations, or other legal requirements. Alternatively, the first set of rules may be configured to ensure compliance with a set of standards, company procedures, etc.

Based upon the evaluation output data, at least one action may be selected from among a set of potential actions (block 186). The set of potential actions may include, for example, automatically generating correspondence associated with the claim, and/or scheduling a future evaluation. Other types of actions may also be included in the set of potential actions, such as generating a manual task instruction (e.g., if it is determined at block 184 that required correspondence cannot be automatically generated, or if it cannot be determined at block 184 whether any correspondence is needed, etc.), retrieving and/or generating one or more attachments (e.g., an estimate, a payment draft, one or more forms, etc.), or modifying the pre-defined list of events that will trigger a future evaluation, etc.

Once selected, the action may be performed (block 188). The selected action or actions may be performed using a second set of rules implemented by the rules engine. The second set of rules may be configured to ensure compliance with one or more state laws or regulations, and/or other legal requirements. Alternatively or additionally, the second set of rules may be configured to ensure compliance with a set of standards, company procedures, etc. The first and second rule sets, and/or the rules engine, may in some embodiments be distributed across different processors, computing devices and/or geographic locations, or may be in a single device/location and/or implemented by a single processor.

In one embodiment where the selected action is automatic generation of the correspondence, block 188 may include selecting, from among a plurality of correspondence templates stored in a memory, a first correspondence template (e.g., a template similar to correspondence template 160 of FIG. 4), and using the first correspondence template to generate the correspondence. Moreover, in such an embodiment, block 188 may include selecting, from among a plurality of sets of text stored in a memory, a first set of text, and placing the first set of text within the first correspondence template. The first correspondence template and/or the first set of text may be selected using the second set of rules, for example. Still further, in such an embodiment, block 188 may include retrieving, from a claims database (e.g., claims database 22 of FIG. 1), one or more additional data elements associated with the claim. If the second set of rules is configured to ensure compliance with one or more state legal requirements, for example, block 188 may include retrieving at least a first data element specifying a state associated with the claim.

In some embodiments, the method 180 may include one or more additional blocks not shown in FIG. 5. If the selected action(s) include(s) automatic generation of a first letter, for example, the method 180 may further include blocks in which it is determined (e.g., using a third set of rules implemented by the rules engine) that the first letter is to be sent out simultaneously with one or more other documents (e.g., another letter, an estimate, a payment, a form, etc.), and statuses of at least some of the one or more other documents may be checked. For example, statuses of each of a number of other documents may be checked until the first instance in which a status of “pending” or “failed” (e.g., rather than “complete”) is identified. The method 180 may also include a block in which, based upon the checked status(es), the first letter either is caused to be sent together with the other document(s) and a cover letter (e.g., if all other statuses are “complete”), or is caused to not be sent (e.g., is stored in a queue or is not yet generated) until at least one of the statuses changes.

As another example, if the selected action(s) include(s) automatic generation of a letter, the method 180 may further include a block in which the generated correspondence is automatically routed to a printer (e.g., to await signature by the appropriate performer prior to sending the letter out). In addition, the method 180 may include blocks in which instructions for manually handling the generated correspondence are generated, and in which the printer is caused to print a cover sheet that includes the generated instructions.

As yet another example, if the selected action(s) include(s) scheduling a future evaluation, the method 180 may further include blocks in which a subsequent evaluation trigger is detected and in which, in response to the trigger, the scheduled future evaluation is performed. The subsequent evaluation trigger may be detected by detecting the occurrence of a subsequent pre-scheduled time corresponding to the scheduled future evaluation, for example.

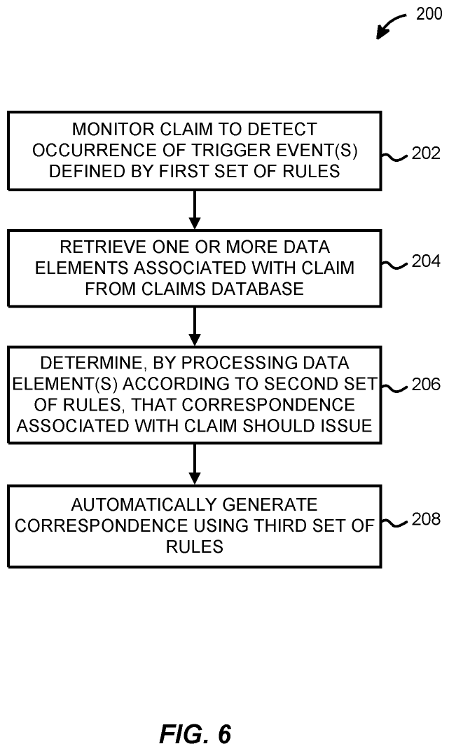

FIG. 6 depicts a flow diagram of another exemplary method 200 for automated management of correspondence related to a claim, according to one embodiment. The method 200 may be implemented by one or more processors of one or more servers and/or other computing device(s), such as one or more processors of ACMS 14 of FIG. 1, for example. The method 200 may correspond to a particular embodiment of the method 180 under a specific scenario (i.e., one in which the action selected at block 186 of the method 180 is the automatic generation of correspondence), or may correspond to an embodiment different than the method 180.

In the method 200, a claim may be monitored to detect the occurrence of one or more triggering events (block 202). The set of triggering events may be defined by a first set of rules implemented by a rules engine, and may include any of the claim-related events described elsewhere herein, and/or other suitable events. Moreover, depending upon the embodiment, the claim may be monitored in various different ways. For example, the claim may be monitored by receiving a “push” notification from a claim management system (e.g., CMS 12 of FIG. 1) each time that a claim-related event occurs (e.g., each time that an event codified within a list of various claim-related events occurs). As another example, the claim may be monitored by requesting event information from the claim management system on a periodic or other suitable basis.

In response to detecting the occurrence of the triggering event(s), an evaluation may be performed. Performing the evaluation may include retrieving one or more data elements associated with the claim from a claims database (block 204), such as claims database 22 of FIG. 1, and then processing the retrieved data element(s) according to a second set of rules implemented by the rules engine to determine that correspondence associated with the claim should issue (block 206). The data elements may include any of the data elements described elsewhere herein, and/or other suitable data elements.

The correspondence may then be automatically generated using a third set of rules implemented by the rules engine (block 208). Block 208 may include various different operations. For example, the correspondence may be automatically generated by selecting, based at least upon the triggering event (e.g., based at least upon the event code or other identifier), a first correspondence template from among multiple different correspondence templates. The selection of the first correspondence template may also depend on one or more of the data elements retrieved at block 204, and/or one or more other data elements (e.g., state, current claim status, etc.).

The correspondence may also be generated by selecting, based at least upon a first data element associated with the claim, a first set of text from among multiple different sets of text, and placing the first set of text within the first correspondence template. In some embodiments and scenarios, additional segments of optional or variable text may also be selected and placed within the first correspondence template at block 208.

In some embodiments, the method 200 may also include one or more additional blocks not shown in FIG. 6. For example, the method 200 may include an additional block in which a printer is caused to print the correspondence, an additional block in which a future evaluation is scheduled, and so on.

### VII. Exemplary Request Staging

In some embodiments evaluations may be performed in parallel, and/or at a very fast rate, such that multiple requests for actions to be taken may be pending at any one time. Moreover, in some embodiments and scenarios, two or more pending requests may both call for the same action to be performed. With reference to FIG. 1, for example, correspondence management module 32 may generate, and pass to implementation module 34, multiple requests for a specific letter to be generated and sent to a specific recipient. If implementation module 34 were to cause the same letter to be sent to the intended recipient multiple times, however, the recipient might be irritated or confused, and the sending entity (e.g., insurance company) might incur needless costs (e.g., postage and printing costs). Thus, in some embodiments, there is a need for processing techniques that reduce or eliminate duplicate correspondence.

In some embodiments, a request staging process may be used to address this problem. FIG. 7 depicts an exemplary process 220 for staging correspondence requests associated with multiple evaluations, according to one embodiment and scenario. The process 220 may be implemented by request staging unit 50 of FIG. 1, for example. In the example process 220, three parallel processing threads 222A-222C correspond to three respective events: the addition of “wind” as a cause of loss for a claim (thread 222A), the addition of “water” as a cause of loss for the claim (thread 222B), and the addition of “lightning” as a cause of loss for the claim (thread 222C). Each of the three events may have been initiated by a claim handler entering information using a loss reporting tool, for example.

At processing stages 224A-224C, it may be determined that the respective event requires that a letter be generated. At processing stages 226A-226C, it may be determined that the required letter has not yet been sent. Thereafter, request staging processes 228A-228C may generate, independently for each of threads 222A-222C, a key that is unique to the letter. While shown as being vertically aligned in FIG. 7, the various processing stages in threads 222A-222C may or may not occur at precisely the same time. For example, processing stage 224A may occur before or after processing stages 224B and/or 224C, processing stage 226B may occur before or after processing stages 226A and/or 226C, and so on.

The keys generated by request staging processes 228A-228C may each include, or be derived from, a number of different data elements. In one embodiment and/or scenario, for example, each of request staging processes 228A-228C generates a key that includes a claim identifier (e.g., the claim number), an identifier of a participant associated with the claim, a number or code of a template selected for the letter, the date, and/or an identifier of a payment made on the claim. Other suitable information may also, or instead, be included in each key.

In the example scenario corresponding to FIG. 7, request staging process 228A completes before request staging processes 228B and 228C. At a process 230A, the key generated by request staging process 228A may be checked against a record stored in a memory, where it may be verified that the same key has not been generated based upon any other request (e.g., within some pre-determined time window, such as the preceding 10 minutes, the preceding hour, etc.). In response, the letter may be generated and/or sent out.

Each of the request staging processes 228B and 228C may generate the same key as request staging process 228A. Thus, at processes 230B and 230C, the stored record may indicate that a request with the same key was already generated (e.g., within the pre-determined time window), and the threads 222B and 22C may therefore be terminated without generating and/or sending additional copies of the letter.

### VIII. Exemplary Process for Identifying a Performer

As discussed above, each piece of correspondence may be associated with one or more performers. A “performer” for a piece of correspondence may be an employee or other individual who is responsible for any follow-up communications regarding the correspondence, for reviewing the correspondence, for signing the correspondence, and/or for taking some other action and/or assuming some other responsibility with respect to the correspondence. Manual tasks may also be assigned to the performer(s), in some embodiments and/or scenarios.

In some scenarios, a performer may simply be identified as the employee or individual who initiated the triggering event. In other scenarios (e.g., where an application has autonomously initiated a triggering event), identification of the appropriate performer may be more difficult or complicated. FIG. 8 depicts one such example process 240 for identifying a performer for automated correspondence, according to one embodiment. The process 240 may be implemented by correspondence management module 32, implementation module 34, and/or another component of ACMS 14 in FIG. 1, for example.

In the example process 240, it may first be determined, at a process stage 242, whether a cause of loss was provided for, or is associated with, the claim. The determination may be made by processing one or more data elements stored in claims database 22 of FIG. 1, for example. If a cause of loss was provided, flow may proceed to process stage 244. If not, flow may proceed to process stage 246.

At process stage 244, information about the cause of loss owner (e.g., an identification number or code, and/or other information associated with the owner) may be retrieved. A “cause of loss owner” may be an employee whose identifier is associated specifically with that cause of loss (e.g., in claims database 22 of FIG. 1). At process stage 248, it may be determined whether the cause of loss owner is a valid employee. An employee may be considered to be “valid” (for purposes of being a performer) if one or more criteria are met, such as not being a manager and/or not having certain other job titles, not belonging to certain departments, etc. If the cause of loss owner is valid, the cause of loss owner may be identified as the performer for the correspondence at a process stage 250. If not, flow may proceed to process stage 252.

At process stage 252, it may be determined whether a team of multiple employees jointly owns the cause of loss. If so, flow may proceed to process stage 254. If not, flow may proceed to process stage 256. At process stage 254, it may be determined whether any other employee on the team of cause of loss owners is valid (e.g., using the same criteria as process stage 248). If so, one of the valid team members may be selected (e.g., randomly) and identified as the performer at process stage 250. If not, flow may proceed to process stage 256.

At process stage 256, it may be determined whether another cause of loss was provided for, or associated with, the claim. If so, flow may proceed back to process stage 244 to retrieve the owner for that cause of loss. If not, flow may proceed to process stage 260.

At process stage 246, it may be determined whether any other employee (e.g., organizational identifier) was provided for, or associated with, the correspondence and/or the event triggering the correspondence. If so, flow may proceed to process stage 262. If not, flow may proceed to process stage 260.

At process stage 262, it may be determined whether the employee identified at process stage 246 is a valid employee (e.g., using the same criteria as process stage 248). If so, the employee may be identified as the performer for the correspondence at process stage 250. If not, flow may proceed to process stage 260.

At process stage 260, it may be determined whether the claim owner is a valid employee (e.g., using the same criteria as process stage 248). A “claim owner” may be an employee whose identifier is associated with the overall claim (e.g., in claims database 22 of FIG. 1). If the claim owner is a valid employee, the claim owner may be identified as the performer for the correspondence at process stage 250. If not, flow may proceed to process stage 264.

At process stage 264, it may be determined whether a team of multiple employees jointly owns the claim. If so, flow may proceed to process stage 266. If not, the claim owner may be identified as the performer for the correspondence at process stage 250, despite not meeting the “valid” employee criteria, simply because no better alternative can be identified.

At process stage 266, it may be determined whether any other employee on the team of claim owners is valid (e.g., using the same criteria as process stage 248). If so, one of the valid team members may be selected (e.g., randomly) and identified as the performer at process stage 250. If not, the claim owner considered at process stage 260 may be identified as the performer for the correspondence at process stage 250, despite not meeting the “valid” employee criteria, simply because no better alternative can be identified.

### IX. Exemplary Computer System for Automated Correspondence Management

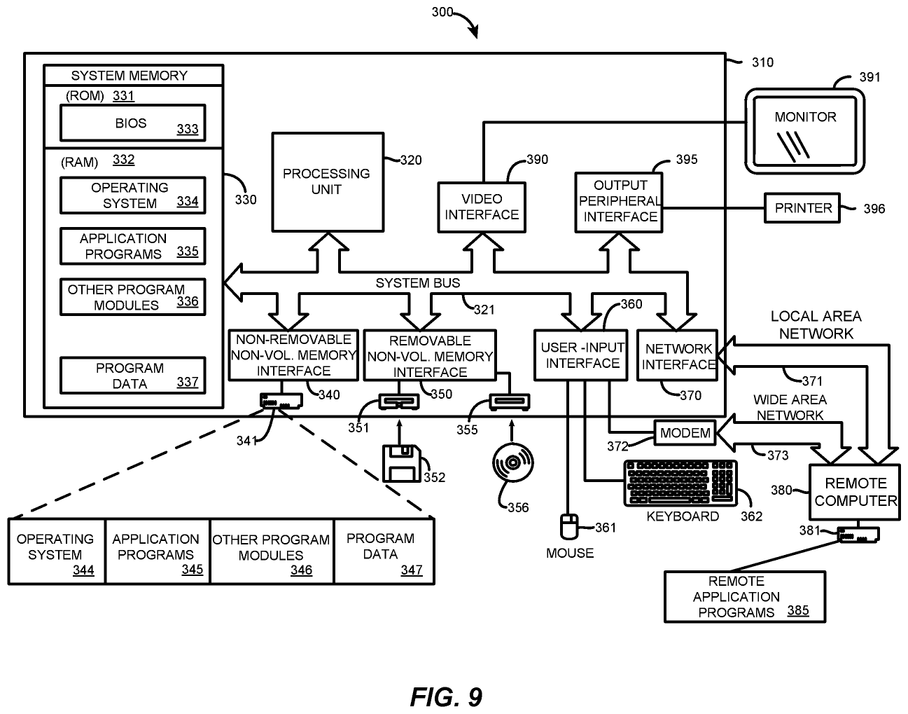

FIG. 9 depicts an exemplary computer system 300 in which the techniques described herein may be implemented, according to an embodiment. The computer system 300 of FIG. 9 may include a computing device in the form of a computer 310. Components of the computer 310 may include, but are not limited to, a processing unit 320, a system memory 330, and a system bus 321 that couples various system components including the system memory 330 to the processing unit 320. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 9 illustrates operating system 334, application programs 335, other program modules 336, and program data 337.

The computer 310 may also include other removable/non-removable, volatile/nonvolatile computer storage media. By way of example only, FIG. 9 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 9 provide storage of computer-readable instructions, data structures, program modules and other data for the computer 310. In FIG. 9, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and may include many or all of the elements described above relative to the computer 310, although only a memory storage device 381 has been illustrated in FIG. 9. The logical connections depicted in FIG. 9 include a local area network (LAN) 371 and a wide area network (WAN) 373, but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 9 illustrates remote application programs 385 as residing on memory device 381.

The techniques for automated correspondence management described above may be implemented in part or in their entirety within a computer system such as the computer system 300 illustrated in FIG. 9. The computer 310 may be included in ACMS 14 of FIG. 1, for example, and the remote application programs 385 may include one or more applications of CMS 12 and/or applications 18 of FIG. 1. Moreover, the functionality of services interface module 30, correspondence management module 32 and/or implementation module 34 of FIG. 1 may be implemented by one or more of application programs 335 and/or other program modules 336.

As another example, rules database 36 of FIG. 1 may be stored in hard disk drive 341 (e.g., as program data 347), magnetic disk 352 and/or optical disk drive 355, and/or the data elements retrieved by correspondence management module 32 and/or implementation module 34 of FIG. 1 may be stored in hard disk drive 341 (e.g., as program data 347) and/or RAM 332 (e.g., as program data 337).

As yet another example, correspondence staging unit 60 of FIG. 1 may cause letters generated by correspondence generator 52, and/or instructions generated by manual task generator 54, to be printed directly on printer 396. Alternatively, printer 396 may instead be coupled to a print server such as print server 16 of FIG. 1.

### X. Exemplary Method Embodiments

In one aspect, a computer-implemented method for automated management of correspondence related to a claim may include (1) detecting, by one or more processors, an evaluation trigger, wherein detecting the evaluation trigger includes detecting at least one of (i) occurrence of a pre-scheduled time, (ii) a triggering event associated with the claim, or (iii) an evaluation request from an application; (2) in response to detecting the evaluation trigger, performing, by the one or more processors, an evaluation, wherein performing the evaluation includes (i) retrieving, from a claims database, one or more data elements associated with the claim, and (ii) generating evaluation output data by processing the retrieved one or more data elements according to a first set of rules implemented by a rules engine; (3) selecting, by the one or more processors and based upon the evaluation output data, at least one action from among a set of potential actions, the set of potential actions including (i) automatically generating correspondence associated with the claim (and/or dynamically generating or configuring the contents or substance of the correspondence) and (ii) scheduling a future evaluation; and (4) performing, by the one or more processors, the selected at least one action using a second set of rules implemented by the rules engine. The method may include additional, fewer or alternative actions, such as any of those discussed elsewhere herein.

For instance, detecting the evaluation trigger may include (1) receiving, from a claims management system, data indicative of a plurality of events associated with a plurality of claims; and (2) processing at least a portion of the received data indicative of the plurality of events to detect the triggering event.

Additionally or alternatively, the data indicative of the plurality of events may include, for each of the events, a respective event payload specifying one or more properties of the event, and processing at least the portion of the received data indicative of the plurality of events may include processing each of the respective event payloads to remove from consideration any events, of the plurality of events, that meet one or more filter criteria.

Additionally or alternatively, one or both of (i) the first set of rules, and (ii) the second set of rules, may be configured to ensure compliance with one or more legal requirements. Additionally or alternatively, performing the selected at least one action may include automatically generating the correspondence associated with the claim.

Additionally or alternatively, automatically generating the correspondence associated with the claim may include (1) selecting, from among a plurality of correspondence templates stored in a memory and using the second set of rules, a first correspondence template; and (2) using the first correspondence template to generate the correspondence.

Additionally or alternatively, automatically generating the correspondence associated with the claim, may include (1) selecting, from among a plurality of sets of text stored in a memory and using the second set of rules, a first set of text; and (2) placing the first set of text within the first correspondence template.

Additionally or alternatively, the second set of rules may be configured to ensure compliance with one or more state legal requirements, and automatically generating the correspondence associated with the claim may include retrieving, from the claims database, one or more additional data elements associated with the claim, including at least a first data element specifying a state associated with the claim.

Additionally or alternatively, the correspondence associated with the claim may be a first letter associated with the claim, and the method may further comprise (1) determining, by the one or more processors and using a third set of rules implemented by the rules engine, that the first letter is to be sent simultaneously with one or more other documents; (2) checking, by the one or more processors, statuses of at least some of the one or more other documents; and (3) based upon the statuses, either (i) causing the first letter to be sent together with the one or more other documents and a cover letter or (ii) causing the first letter to not be sent until at least one of the statuses changes.

Additionally or alternatively, the method may further include automatically routing the generated correspondence to a printer. Additionally or alternatively, the method may further include (1) generating instructions for manually handling the generated correspondence; and (2) causing the printer to print a cover sheet that includes the generated instructions. Additionally or alternatively, the set of potential actions may further include generating a manual task instruction.

Additionally or alternatively, performing the selected at least one action may include scheduling the future evaluation, and the method may further include (1) detecting, by the one or more processors, a subsequent evaluation trigger, wherein detecting the subsequent evaluation trigger includes detecting occurrence of a subsequent pre-scheduled time corresponding to the scheduled future evaluation; and (2) in response to detecting the subsequent evaluation trigger, performing, by the one or more processors, the scheduled future evaluation.

Additionally or alternatively, detecting the evaluation trigger may include detecting that at least one of a set of pre-defined events associated with the claim has occurred, and the set of pre-defined events may include one or more of (i) opening the claim, (ii) closing the claim, (iii) adding a participant associated with the claim, (iv) updating a participant associated with the claim, (v) creating a cause of loss for the claim, (vi) reviewing the claim, (vii) adding a vehicle associated with the claim, (viii) updating a vehicle associated with the claim, (ix) making a payment associated with the claim, (x) opening subrogation for the claim, or (xi) closing subrogation for the claim.

Additionally or alternatively, retrieving one or more data elements associated with the claim may include retrieving one or more of (i) a state associated with the claim, (ii) information about an insured or participant associated with the claim, (iii) information about a policy associated with the insured, (iv) information about a vehicle associated with the claim, (iv) information about a cause of loss associated with the claim, (v) information about a claim handler for the claim, or (vi) information about a personal injury associated with the claim.

In another aspect, a computer-implemented method for automated management of correspondence related to a claim may include (1) monitoring, by one or more processors, the claim to detect an occurrence of at least one triggering event of a set of one or more triggering events, the set of one or more triggering events being defined by a first set of rules implemented by a rules engine; (2) in response to detecting the occurrence of the at least one triggering event, performing, by the one or more processors, an evaluation, wherein performing the evaluation may include (i) retrieving, from a claims database, one or more data elements associated with the claim, and (ii) determining, by processing the retrieved one or more data elements according to a second set of rules implemented by the rules engine, that correspondence associated with the claim should issue; and/or (3) automatically generating, by the one or more processors and using a third set of rules implemented by the rules engine, the correspondence (and/or substance or contents thereof) associated with the claim. The method may include additional, fewer or alternative actions, such as any of those discussed elsewhere herein.

For instance, automatically generating the correspondence associated with the claim may include (1) selecting, from among a plurality of correspondence templates and based at least upon the triggering event, a first correspondence template; (2) selecting, from among a plurality of sets of text and based at least upon a first data element associated with the claim, a first set of text; and (3) placing the first set of text within the first correspondence template.

### XI. Exemplary Computing Device Embodiments

In one aspect, a system for automated management of correspondence related to a claim includes (1) a claims management system comprising a first set of one or more computing devices and a claims database; and (2) an automated correspondence management system in communication with the claims management system and comprising a second set of one or more computing devices and a rules database. The second set of one or more computing devices may be configured to (A) detect an evaluation trigger, at least by detecting at least one of (i) occurrence of a pre-scheduled time, (ii) a triggering event associated with the claim, or (iii) an evaluation request from an application; (B) in response to detecting the evaluation trigger, perform an evaluation, at least by (i) retrieving, from the claims database, one or more data elements associated with the claim, and (ii) generating evaluation output data by processing the retrieved one or more data elements according to a first set of rules stored in the rules database; (C) select, based upon the evaluation output data, at least one action from among a set of potential actions, the set of potential actions including (i) automatically generating correspondence associated with the claim (and/or dynamically generating or selecting the contents of one or more fields or portions of the correspondence based upon various factors discussed herein), and (ii) scheduling a future evaluation; and (D) perform the selected at least one action using a second set of rules stored in the rules database. The system may include additional, fewer or alternative components, and/or components with additional, less or alternative functionality, such as any of the components and/or functionality discussed elsewhere herein.

For instance, the at least one action may include automatically generating the correspondence. Additionally or alternatively, the system may further include one or more memories, wherein the second set of one or more computing devices is configured to generate the correspondence associated with the claim at least by (1) selecting, from among a plurality of correspondence templates stored in the one or more memories, a first correspondence template; (2) selecting, from among a plurality of sets of text stored in the one or more memories, a first set of text; and (3) placing the first set of text within the first correspondence template.

### XII. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for automated correspondence management through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A computer-implemented method for automatically generating correspondence, the method comprising:
exposing, by a services interface module of an automated correspondence management system (ACMS) implemented by one or more processors, an application programming interface (API) of the services interface module configured to receive event notifications from one or more applications via a network;
receiving, at the API of the ACMS, a plurality of event notifications of a corresponding plurality of events from the one or more applications, each of the event notifications including a respective event payload containing data specifying one or more properties of the respective event;
applying, by an event filter of the ACMS, a set of filter rules to the event payloads of the plurality of event notifications to generate a processing subset of the plurality of event notifications by removing a subset of the plurality of event notifications that match the filter rules;
processing, by an evaluation unit of the ACMS, the event payload of each of the event notifications of the processing subset to detect event triggers associated with events indicated by the event notifications;
when an evaluation trigger associated with one or more of the event notifications is detected, generating, by the evaluation unit of the ACMS, evaluation output data associated with the one or more event notifications by:
retrieving one or more additional data elements associated with the one or more event notifications from a database via the network; and
applying an evaluation rule set to the corresponding event payloads and additional data elements associated with the one or more event notifications to generate the evaluation output data;
determining, by an implementation module of the ACMS, a type of correspondence associated with the one or more event notifications based upon the evaluation output data;
generating, by the implementation module of the ACMS, a correspondence document based upon the evaluation output data;
selecting, by the implementation module of the ACMS, a printer associated with a type of action for the correspondence document based upon the evaluation output data; and
routing, by the implementation module of the ACMS, the correspondence document to the printer to cause the printer to print the correspondence document.

2. The computer-implemented method of claim 1, wherein generating the correspondence document comprises:
selecting one or more correspondence templates for the one or more event notifications based upon the evaluation output data; and
populating a plurality of fields in the one or more correspondence templates with event-related data from the database.

3. The computer-implemented method of claim 2, wherein the one or more correspondence templates comprise a plurality of correspondence templates, and wherein generating the correspondence document further comprises:
combining the plurality of correspondence templates into the correspondence document after populating the plurality of fields.

4. The computer-implemented method of claim 1, wherein the correspondence document is a first letter to a recipient associated with the event, and further comprising:
determining, by the implementation module of the ACMS, that the correspondence document is to be sent simultaneously with one or more additional correspondence documents to the recipient;
checking, by the implementation module of the ACMS, statuses of at least some of the one or more additional correspondence documents; and
delaying, by the implementation module of the ACMS, routing the correspondence document to the printer until at least one of the additional correspondence documents is determined to be generated based upon the statuses; and
adding, by the implementation module of the ACMS, the at least one additional correspondence document to the correspondence document prior to routing the correspondence document to the printer.

5. The computer-implemented method of claim 1, wherein the set of filter rules include filter criteria indicating conditions under which correspondence need not be sent for types of event.

6. The computer-implemented method of claim 1, wherein processing the event payloads of the processing subset to detect event triggers further comprises:
identifying one or more events to be reevaluated at a future time based upon the respective event payloads; and
scheduling the one or more events to be processed again at the future time to detect event triggers.

7. The computer-implemented method of claim 1, wherein the event filter is configured not to retrieve or process data beyond data contained in event payloads of event notifications.

8. The computer-implemented method of claim 1, wherein each event comprises a user modification of a claim, and wherein the one or more additional data elements comprise data associated with the respective claim, comprising one or more of: (i) a state associated with the claim, (ii) information about an insured or participant associated with the claim, (iii) information about a policy associated with the insured, (iv) information about a vehicle associated with the claim, (iv) information about a cause of loss associated with the claim, (v) information about a claim handler for the claim, or (vi) information about a personal injury associated with the claim.

9. A system for automatically generating correspondence, the system comprising:
one or more computing devices comprising one or more processors configured to implement an automated correspondence management system (ACMS) and communicatively connected to one or more additional computing devices implementing one or more applications, the ACMS comprising:
(i) a services interface module configured to:
expose an application programming interface (API) of the services interface module configured to receive event notifications from the one or more applications via a network; and
receive at the API a plurality of event notifications of a corresponding plurality of events from the one or more applications, each of the event notifications including a respective event payload containing data specifying one or more properties of the respective event;
(ii) an event filter configured to apply a set of filter rules to the event payloads of the plurality of event notifications to generate a processing subset of the plurality of event notifications by removing a subset of the plurality of event notifications that match the filter rules;
(iii) an evaluation unit configured to:
process the event payload of each of the event notifications of the processing subset to detect event triggers associated with events indicated by the event notifications;
when an evaluation trigger associated with one or more of the event notifications is detected, generate evaluation output data associated with the one or more event notifications by:
retrieving one or more additional data elements associated with the one or more event notifications from a database via the network; and
applying an evaluation rule set to the corresponding event payloads and additional data elements associated with the one or more event notifications to generate the evaluation output data; and
(iv) an implementation module configured to:
determine a type of correspondence associated with the one or more event notifications based upon the evaluation output data;
generate a correspondence document based upon the evaluation output data;
select a printer associated with a type of action for the correspondence document based upon the evaluation output data; and
route the correspondence document to the printer to cause the printer to print the correspondence document.

10. The system of claim 9, wherein the implementation module is configured to generate the correspondence document by:
selecting a plurality of correspondence templates for the one or more event notifications based upon the evaluation output data;
populating a plurality of fields in each of the plurality of correspondence templates with event-related data from the database; and
combining the plurality of correspondence templates into the correspondence document after populating the plurality of fields.

11. The system of claim 9, wherein the correspondence document is a first letter to a recipient associated with the event, and wherein the implementation unis is further configured to:
determine that the correspondence document is to be sent simultaneously with one or more additional correspondence documents to the recipient;
check statuses of at least some of the one or more additional correspondence documents; and
delay routing the correspondence document to the printer until at least one of the additional correspondence documents is determined to be generated based upon the statuses; and
add the at least one additional correspondence document to the correspondence document prior to routing the correspondence document to the printer.

12. The system of claim 9, wherein the set of filter rules include filter criteria indicating conditions under which correspondence need not be sent for types of event.

13. The system of claim 9, wherein the evaluation unit is configured to process the event payloads of the processing subset to detect event triggers by:
identifying one or more events to be reevaluated at a future time based upon the respective event payloads; and
scheduling the one or more events to be processed again at the future time to detect event triggers.

14. A tangible, non-transitory computer-readable medium storing executable instructions for automatically generating correspondence that, when executed by one or more processors of a computer system, cause the computer system to implement an automated correspondence management system (ACMS) configured to:
expose, by a services interface module of the ACMS, an application programming interface (API) of the services interface module configured to receive event notifications from one or more applications via a network;
receive, at the API of the ACMS, a plurality of event notifications of a corresponding plurality of events from the one or more applications, each of the event notifications including a respective event payload containing data specifying one or more properties of the respective event;
apply, by an event filter of the ACMS, a set of filter rules to the event payloads of the plurality of event notifications to generate a processing subset of the plurality of event notifications by removing a subset of the plurality of event notifications that match the filter rules;
process, by an evaluation unit of the ACMS, the event payload of each of the event notifications of the processing subset to detect event triggers associated with events indicated by the event notifications;
when an evaluation trigger associated with one or more of the event notifications is detected, generate, by the evaluation unit of the ACMS, evaluation output data associated with the one or more event notifications by:
retrieving one or more additional data elements associated with the one or more event notifications from a database via the network; and
applying an evaluation rule set to the corresponding event payloads and additional data elements associated with the one or more event notifications to generate the evaluation output data;
determine, by an implementation module of the ACMS, a type of correspondence associated with the one or more event notifications based upon the evaluation output data;
generate, by the implementation module of the ACMS, a correspondence document based upon the evaluation output data;
select, by the implementation module of the ACMS, a printer associated with a type of action for the correspondence document based upon the evaluation output data; and
route, by the implementation module of the ACMS, the correspondence document to the printer to cause the printer to print the correspondence document.

15. The tangible, non-transitory computer-readable medium of claim 14, wherein the executable instructions that cause the implementation module to generate the correspondence document cause the implementation module to:
select one or more correspondence templates for the one or more event notifications based upon the evaluation output data; and
populate a plurality of fields in the one or more correspondence templates with event-related data from the database.

16. The tangible, non-transitory computer-readable medium of claim 15, wherein the one or more correspondence templates comprise a plurality of correspondence templates, and wherein the executable instructions that cause the implementation module to generate the correspondence document cause the implementation module to:
combine the plurality of correspondence templates into the correspondence document after populating the plurality of fields.

17. The tangible, non-transitory computer-readable medium of claim 14, wherein the correspondence document is a first letter to a recipient associated with the event, and wherein the executable instructions further cause the ACMS to:
determine, by the implementation module of the ACMS, that the correspondence document is to be sent simultaneously with one or more additional correspondence documents to the recipient;
check, by the implementation module of the ACMS, statuses of at least some of the one or more additional correspondence documents; and
delay, by the implementation module of the ACMS, routing the correspondence document to the printer until at least one of the additional correspondence documents is determined to be generated based upon the statuses; and
add, by the implementation module of the ACMS, the at least one additional correspondence document to the correspondence document prior to routing the correspondence document to the printer.

18. The tangible, non-transitory computer-readable medium of claim 14, wherein the set of filter rules include filter criteria indicating conditions under which correspondence need not be sent for types of event.

19. The tangible, non-transitory computer-readable medium of claim 14, wherein the executable instructions that cause the evaluation unit to process the event payloads of the processing subset to detect event triggers further cause the evaluation unit to:
identify one or more events to be reevaluated at a future time based upon the respective event payloads; and
schedule the one or more events to be processed again at the future time to detect event triggers.

20. The tangible, non-transitory computer-readable medium of claim 14, wherein the event filter is configured not to retrieve or process data beyond data contained in event payloads of event notifications.
